(19) United States
(12) Patent Application Publication
(10) Pub. No.: US 2026/0210320 A1
(43) Pub. Date: Jul. 23, 2026

(54) INJECTOR FOR LIQUID OR GASEOUS FUELS AND METHOD FOR OPERATING SUCH AN INJECTOR

(71) Applicant: Robert Bosch GmbH, Stuttgart (DE)

(72) Inventor: Alexander Fuchs, Adnet (AT)

(21) Appl. No.: 19/140,139

(22) PCT Filed: Nov. 22, 2023
(86) PCT No.: PCT/EP2023/082704

§ 371 Date: Jul. 22, 2025

(30) Foreign Application Priority Data
Dec. 19, 2022 (DE) 10 2022 213 925.9

(51) Int. Cl. F02M 55/00; F02M 21/02; F02M 25/00

(52) U.S. Cl. CPC F02M 55/008; F02M 21/0254; F02M 25/00; F02M 55/004; F02M 2200/9015

(57) ABSTRACT

Injector (1) for the metered dispensing of a gaseous or liquid fuel, having a housing (2) which has a fuel chamber (11) which is fillable with fuel under an injection pressure, and a valve body (3) which is surrounded by a casing tube (7), wherein an intermediate space is formed between the valve body (3) and the casing tube (7), which is part of the fuel chamber (11), wherein one end of the casing tube (7) forms a sealing point (40) with the valve body (3) in order to seal the fuel chamber (11) off from the outside. A return chamber (45) is formed in the housing (2), which is connected to a return line (46) and is separated from the fuel chamber (11) by the sealing point (40).

### BACKGROUND

The invention is based on an injector for metered dispensing of a liquid or gaseous fuel, such as is preferably used to introduce fuel into a combustion chamber or an intake tract of an internal combustion engine.

In internal combustion engines operated with gaseous or liquid fuels, the fuel is metered either into the intake tract of the internal combustion engine or directly into a combustion chamber of the internal combustion engine. Injectors are used that are supplied with the compressed fuel, which is thus under injection pressure, and dispense it in the required amount and at the desired time, under electronic control. For this purpose, the injectors have a movable valve element, which is movable via an electromagnet or another electric actuator, wherein a dispensing orifice is actuated to open or closed by the movement of the valve element. Such an injector is known, for example, from DE 10 2021 200 689 A1 and comprises a piston-type nozzle needle as a valve element, which is arranged longitudinally displaceable in the housing of the injector. The fuel is fed through a fuel chamber inside the injector and thus passes from one end, where the fuel inlet is located, to the outlet end, where the injection opening is formed. The valve element is surrounded by a lubricant chamber for low-friction mounting of the valve element. To prevent the fuel and lubricant from mixing, both chambers of the injector are sealed off from each other.

The injector consists of several components that are connected together during assembly. Seals must be formed at the interfaces between components to reliably prevent, on the one hand, fuel from leaking out of the injector and, on the other hand, any mixing of lubricant and fuel. This is particularly difficult when using hydrogen as a fuel, as hydrogen may easily diffuse into even small gaps.

Injectors for large internal combustion engines are designed for long service lives and are correspondingly cost-intensive. Therefore, such injectors are often repaired when their function is impaired by wear, in order to allow continued use. For this purpose, the injector must be disassembled in order to either replace the individual components or—if applicable, after cleaning—reuse them. Sealing the components off from one another and to the outside by means of welded connections is therefore generally not an option, since welded connections cannot be non-destructively separated and thus hinder or prevent disassembly.

### SUMMARY

The injector according to the invention has the advantage that it can be disassembled into its individual components non-destructively, while at the same time ensuring reliable sealing of the fuel-carrying parts of the injector. For this purpose, the injector has a housing, which comprises a valve body with a fuel inlet via which a fuel chamber formed in the housing is fillable with fuel. The valve body is surrounded by a casing tube, wherein an intermediate space is formed between the casing tube and the valve body, which is part of the fuel chamber, wherein one end of the casing tube forms a sealing point with the valve body in order to seal the fuel chamber to the outside. A return chamber is formed in the housing, which is connected to a return line, and is separated from the fuel chamber by the sealing point.

The return chamber is used to receive fuel that passes through the sealing point due to leaks at the sealing point or due to micro-leakage, as may occur, in particular, when using hydrogen as fuel. The fuel entering the return chamber is discharged from the injector via a return line, such that the return chamber may always be kept at a low pressure. As a certain amount of leakage is therefore tolerable at the seals, the injector may be repaired by replacing or reconditioning individual components. This function is retained even after the components have been dismantled and reassembled.

In a first advantageous embodiment of the invention, the sealing point comprises a first sealing ring and a second sealing ring, which are arranged parallel to one another, and which are clamped between the casing tube and the valve body, wherein the annular space bounded by the sealing rings is connected to the return chamber. If fuel gets past the first sealing ring from the fuel chamber, this fuel is fed into the return chamber and discharged via the return line. The second sealing ring ensures that all fuel escaping in this manner is received by the return chamber. Such a seal may advantageously also be formed between a nozzle body and the casing tube, wherein the nozzle body forms the combustion-chamber-side end of the injector, in which an injection opening is formed.

In a further advantageous development of the invention, the sealing rings surround the valve body. The rotationally symmetrical seal formed in this way allows great freedom in the design and, therefore, easy adaptation of the injector to different installation situations. Preferably, the sealing rings are made of an elastic material, in particular, an elastomer.

In a further development of the invention, it may be provided that a sealing point is formed between the nozzle body and a solenoid body, wherein the solenoid body surrounds an electromagnet. This allows the inside of the injector to be sealed off from the fuel in order to protect the components there from the fuel

In a further advantageous embodiment, the valve element is surrounded, at least in sections, by a first corrugated bellows, which delimits a lubricant chamber that is fillable with a lubricant. This may be sealed off from the fuel by means of the seals according to the invention, such that lubrication of the valve element is maintained over its service life.

In a method according to the invention for operating the proposed injector, the pressure in the return chamber is maintained at a pressure which is below the pressure in the fuel chamber. This prevents gas or liquid from entering the fuel chamber from the return chamber and causing contamination or damage therein. The pressure in the return chamber is preferably ambient pressure.

### BRIEF DESCRIPTION OF THE DRAWINGS

The drawing shows an exemplary embodiment of the injector according to the invention. Shown are

FIG. 1 a longitudinal section through an injector according to the invention, wherein only the essential parts of the injector are shown,

FIG. 2 an enlarged view of the section of FIG. 1 labeled II.

### DETAILED DESCRIPTION

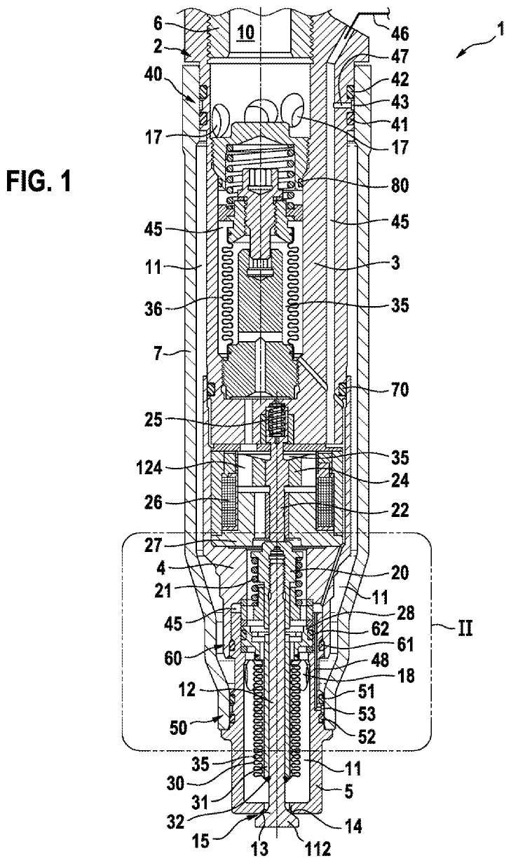

In FIG. 1, an injector according to the invention for the metered dispensing of liquid or gaseous fuel is shown in longitudinal section, wherein the injector 1 is configured, in particular, to dispense fuel into a combustion chamber or an intake tract of an internal combustion engine. The injector 1 has a housing 2, which comprises a valve body 3 with a connection body 6, a solenoid body 4, and a nozzle body 5, which are adjacent to one another and are braced against one another in the longitudinal direction by a clamping device not shown in detail, or connected by screw connections. The valve body 3 is surrounded by a hollow cylindrical casing tube 7, such that an annular space is formed between the valve body 3 and the casing tube 7. This annular space is part of a fuel chamber 11, which is fillable with gaseous or liquid fuel under injection pressure via the connection body 6 screwed into the valve body 3 and a fuel inlet 10 formed therein. The injection pressure depends on the fuel used and the type and operating condition of the internal combustion engine and is, for example, 30 to 300 bar (3 to 30 MPa) when using gaseous fuel such as hydrogen or natural gas.

The fuel inlet 10 is connected via connecting bores 17 to the part of the fuel chamber 11 delimited by the casing tube 7, such that the fuel may flow through the fuel chamber 11 and via further connecting bores 18 into the nozzle body 5. A piston-type valve element 12 is longitudinally displaceably arranged in the nozzle body 5 and has a valve disk 112 at its outlet end, which projects through an injection opening 15 formed in the nozzle body 5. A sealing surface 14 is formed on the valve disk 112, which interacts with a valve seat 13 surrounding the injection opening 15 to open and close the injection opening 15. When the valve element 12 moves out of the nozzle body 5, an annular gap is actuated to open between the sealing surface 14 and the valve seat 13, through which fuel flows out of the fuel chamber 11 to the outside. When the valve element 12 rests against the valve seat 13, the injection opening 15 is closed.

The valve element 12 is received, at its end facing away from the valve disk 112, in a guide sleeve 20. A closing spring 21 is received under preload between the guide sleeve 20 and a shoulder in the housing 2, exerting a closing force on the valve element 12 in the direction of the nozzle body 5. The guide sleeve 20 bears, on the side facing away from the valve element 12, against a longitudinally movable pin 22, which is connected to a solenoid armature 24. Aligned with the pin 22, a damping piston 25 is arranged in the valve body 3, which provides damping during the closing movement of the valve element 12, such that the valve disk 112 comes to rest on the valve seat 13 in a decelerated manner, thereby reducing mechanical stress.

An electromagnet 26 is arranged in the solenoid body 4 at the level of the pin 22, which annularly surrounds the solenoid armature 24, and whose magnetic field is amplified and directed by an inner pole 27. When the electromagnet 26 is energized, a force acts on the solenoid armature 24, which pulls it in the direction of the outlet opening 15 against the force of the closing spring 21, such that the injection opening 15 is actuated to open and fuel exits from the fuel chamber 11. When the current supply to the electromagnet 26 is stopped, the closing spring 21 pushes the valve element 12 back into its closed position and the outlet opening 15 is closed again.

The valve element 12 is surrounded by a valve sleeve 31, which in turn is surrounded by a first corrugated bellows 30. By means of a welded connection 32, the corrugated bellows 30 is sealingly connected to the valve sleeve 31, and the valve sleeve 31 is connected to the valve element 12, such that the valve sleeve 31 moves together with the valve element 12 in the longitudinal direction. The other end of the corrugated bellows 30 is sealingly connected to a disk 28. The first corrugated bellows 30 encloses a lubricant chamber 35, which extends past the closing spring 21, the solenoid armature 24, and the damping piston 25 into the section of the valve body 3 that faces away from the valve element. There, the lubricant chamber 35 is delimited by a second corrugated bellows 36, which forms a compensating chamber. When the valve element 12 moves in the opening and closing direction, the volume of the lubricant chamber in the nozzle body 5 changes, which is compensated for by the second corrugated bellows 36. In order to allow the lubricant to flow freely in the section of the solenoid armature 24, a plurality of longitudinal bores 124 are formed in the solenoid armature 24. The lubricant chamber 35 is filled with a liquid lubricant, such as a suitable mineral oil, in order to lubricate the guide sections of the valve element 12 and thus enable low-friction movement of the valve element 12.

At its upper end in FIG. 1, the casing tube 7 is sealingly connected to the valve body 3 by a seal 40 consisting of a first sealing ring 41 and a second sealing ring 42 between the casing tube 7 and the valve body 3. The seal 40 prevents fuel from escaping the fuel chamber 11 to the outside, which must always be ensured, especially with gaseous fuels. The sealing rings 41, 42 are made of an elastic material, for example, an elastomer. Between the two sealing rings 41, 42, an annular space 43 is formed between the casing tube 7 and the valve body 3, which is connected to a return chamber 45 via a connecting bore 47. Since it is difficult to completely prevent minor micro-leakage at seals, any escaping fuel is received in the return chamber 45, and discharged from the injector 1 via a return line 46. The return chamber 45 is in the form of a plurality of interconnected bores in the housing 2, and extends from the valve body 3 via the solenoid body 4 into the nozzle body 5. A low pressure is always present in the return chamber 45, which is lower than the pressure in the fuel chamber 11, preferably, ambient pressure.

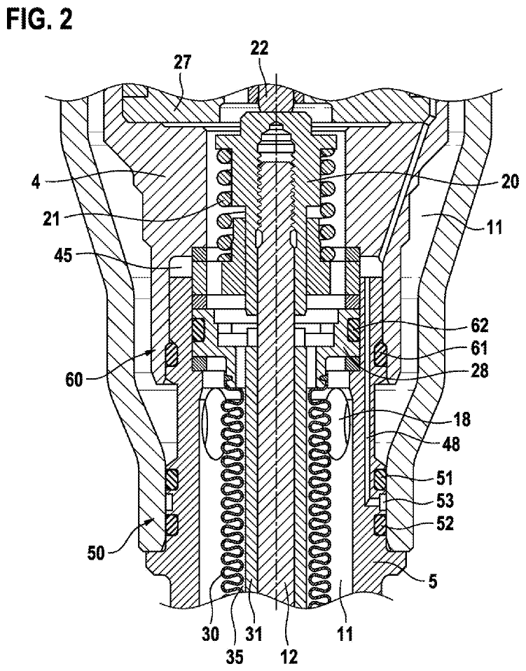

The opposite, second end of the casing tube 7 forms a second seal 50 with the nozzle body 5, which also consists of two parallel sealing rings 51, 52 that delimit an annular space 53. Here too, the annular space 53 is connected to the return chamber 45 via a connecting bore 48, such that any fuel that may pass the first sealing ring 51 is discharged through the return chamber 45. FIG. 2 shows this section of the injector 1 again in an enlarged view of the section marked II of FIG. 1 for clarification.

The connection between the solenoid body 4 and the nozzle body 5 is formed by a seal 60, which comprises a first sealing ring 61, which is clamped between the solenoid body 4 and the nozzle body 5. If fuel from the fuel chamber 11 gets past the sealing ring 61, it also enters the return chamber 45 here. A second sealing ring 62 is arranged on the inside of the nozzle body 5, which seals the return chamber 45 against the fuel inside the nozzle body 5.

Further seals are arranged between the solenoid body 4 and the valve body 3 at the level of the damping piston 25 in the form of a seal 70, and between the interior of the valve body 3 and the connection body 6 in the form of a seal 80, wherein both seals 70, 80 are formed by sealing rings.

The seals 40, 50, 60, 70, 80 are arranged in such a way that fuel escaping from the fuel chamber 11 is collected in the return chamber 45 and discharged via the return line. The injector 1 may therefore be disassembled non-destructively for the purpose of repair and, after reconditioning or replacement of individual components, reassembled without compromising the sealing integrity of the fuel chamber 11.

As fuel flowing out via the return line 46 is an indication of a leak in the injector 1, this may be used to detect leaks. A corresponding sensor is fitted in the return line 46, which signals a malfunction if a predeterminable concentration of fuel in the return line 46 is exceeded, such that the injector 1 in question may be replaced or repaired.

1. An injector (1) for metered dispensing of a gaseous or liquid fuel, having a housing (2) which has a fuel chamber (11) which is fillable with fuel under an injection pressure, and a valve body (3), which is surrounded by a casing tube (7), wherein an intermediate space is formed between the valve body (3) and the casing tube (7), which intermediate space is part of the fuel chamber (11), wherein one end of the casing tube (7) forms a sealing point (40) with the valve body (3) in order to seal the fuel chamber (11) to outside,
wherein a return chamber (45) is formed in the housing (2), which is connected to a return line (46), and which is separated from the fuel chamber (11) by the sealing point (40).

2. The injector (1) according to claim 1, wherein the sealing point (40) comprises a first sealing ring (41) and a second sealing ring (42), which are arranged parallel to one another, and which are clamped between the casing tube (7) and the valve body (3), such that an annular space (43) is delimited between the first sealing ring (41) and the second sealing ring (42), wherein the annular space (43) is connected to the return chamber (45).

3. The injector (1) according to claim 1, wherein the housing (2) comprises a nozzle body (5) which forms a combustion-chamber-side end of the injector (1), and in which a valve element (12) controlling an injection opening (15) is arranged, wherein the nozzle body (5) forms a second sealing point (50) with the casing tube (7), and the sealing point comprises two parallel sealing rings (51; 52), which are clamped between the casing tube (7) and the nozzle body (5), wherein an annular space (53) between the two sealing rings (51; 52) is connected to the return chamber formed in the valve body (3).

4. The injector according to claim 2, wherein the sealing rings (41; 42) surround the valve body (3).

5. The injector according to claim 2, wherein the sealing rings (41; 42) are made of an elastic material.

6. The injector according to claim 3, wherein the nozzle body (5) forms a further sealing point (60) with a solenoid body (4), wherein the solenoid body (4) surrounds an electromagnet (26).

7. The injector according to claim 3, wherein the valve element (12) is surrounded at least in sections by a first corrugated bellows (30), which delimits a lubricant chamber (35) that is fillable with a lubricant.

8. The injector according to claim 1, wherein a fuel sensor for ascertaining a fuel concentration is arranged in the return line (46).

9. A method for operating an injector according to claim 1,
wherein the return chamber (45) is maintained at a pressure which is lower than a pressure in the fuel chamber (11).

10. The method according to claim 9, wherein the return chamber (45) is at ambient pressure (0.1 MPa absolute).

11. The injector according to claim 5, wherein the sealing rings (41; 42) are made of an elastomer.

12. The injector (1) according to claim 2, wherein the housing (2) comprises a nozzle body (5) which forms a combustion-chamber-side end of the injector (1), and in which a valve element (12) controlling an injection opening (15) is arranged, wherein the nozzle body (5) forms a second sealing point (50) with the casing tube (7), and the sealing point comprises two parallel sealing rings (51; 52), which are clamped between the casing tube (7) and the nozzle body (5), wherein an annular space (53) between the two sealing rings (51; 52) is connected to the return chamber (45) formed in the valve body (3).
